(19) United States
(12) Patent Application Publication
(10) Pub. No.: US 2005/0144615 A1
(43) Pub. Date: Jun. 30, 2005

(54) Modularized custom-developed software package producing method and system

(76) Inventors: Shu-Chuan Chen, Taipei (TW); Chen-Pin Lee, Taipei (TW); Fei-Wen Chen, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/750,624

(22) Filed: Dec. 29, 2003

(51) Int. Cl. G06F 9/44

(52) U.S. Cl. 717/169; 717/120

(57) ABSTRACT

A modularized custom-developed software package producing method and system is proposed, which is capable of automatically producing a custom-developed software package based on customer-designated specifications; and which is characterized by the provision of all required functional and data objects as modularized objects, including a software core module object, a group of functional module objects, and a group of custom-made module objects, which can be selectively chosen to be gathered and combined into an integrated code package serving as the intended custom-developed software package. The proposed method and system allows the overall software development process to be less laborious and time-consuming and thus more efficient to implement, and can help prevent confidential business documents and data files that are embedded in the custom-developed software package from unauthorized access and tampering.

### BACKGROUND OF THE INVENTION

1. Field of the Invention

This invention relates to information technology, and more particularly, to a modularized custom-developed software package producing method and system, which is capable of automatically producing a custom-developed software package based on customer-designated specifications.

2. Description of Related Art

Custom-developed software is a special-purpose computer program that is developed by a software developer for customers based on customer-designated specifications to offer customer-desired functionality. In practice, a software developer can develop a variety of different custom-developed software packages based on the same core module with added functions based on different requirements from different customers.

One drawback to conventional way of producing custom-developed software packages is that in order to meet the different requirements from different customers, it is usually needed to spend much labor and time on code modifications to pre-built programs, which makes the development process quite laborious and time-consuming and thus quite inefficient. In addition, conventional methodology for making custom-developed software often requires a major code modification on the software when only a slight change to the functionality is intended. Moreover, most custom-developed software packages are embedded with confidential business documents and data files, but conventional custom-developed software development procedures would easily allow unauthorized access and tampering to these confidential files since they are exposed to too many people during the development process. Furthermore, when a custom-developed software package needs to be modified or upgraded, the conventional unmodularized architecture would make the software reengineering very difficult to implement.

### SUMMARY OF THE INVENTION

It is therefore an objective of this invention to provide a modularized custom-developed software package producing method and system that allows the development and modification of a custom-developed software package to be less laborious and time-consuming and more efficient to implement.

It is another objective of this invention to provide a modularized custom-developed software package producing method and system which can help prevent confidential business documents and data files that are to be embedded in the custom-developed software package from unauthorized access and tampering

The modularized custom-developed software package producing method and system according to the invention is designed to be capable of automatically producing a custom-developed software package based on customer-designated specifications; and which is characterized by the provision of all required functional and data objects as modularized objects, including a software core module object, a group of functional module objects including core functional module objects and custom-made functional module objects, and a group of custom-made module objects including document file objects, data file objects, and custom-made interface objects, which can be selectively chosen to be gathered and combined into an integrated code package serving as the intended custom-developed software package.

Compared to prior art, the modularized custom-developed software package producing method and system according to the invention allows the overall software development process to be less laborious and time-consuming and thus more efficient to implement. Moreover, the invention can help prevent confidential business documents and data files that are embedded in the custom-developed software package from unauthorized access and tampering, since these files are stored by authorized personnel into the custom-made module storage unit and directly gathered and integrated to the custom-developed software package without human intervention.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an object-oriented component model of the modularized custom-developed software package producing system according to the invention;

FIG. 2A is a schematic diagram showing the database structure of a software core module storage unit included in the modularized custom-developed software package producing system of the invention;

FIG. 2B is a schematic diagram showing the database structure of a functional module storage unit included in the modularized custom-developed software package producing system of the invention;

FIG. 2C is a schematic diagram showing the database structure of a custom-made module storage unit included in the modularized custom-developed software package producing system of the invention.

### DETAILED DESCRIPTION OF PREFERRED EMBODIMENTS

The modularized custom-developed software package producing method and system according to the invention is disclosed in full details by way of preferred embodiments in the following with reference to the accompanying drawings.

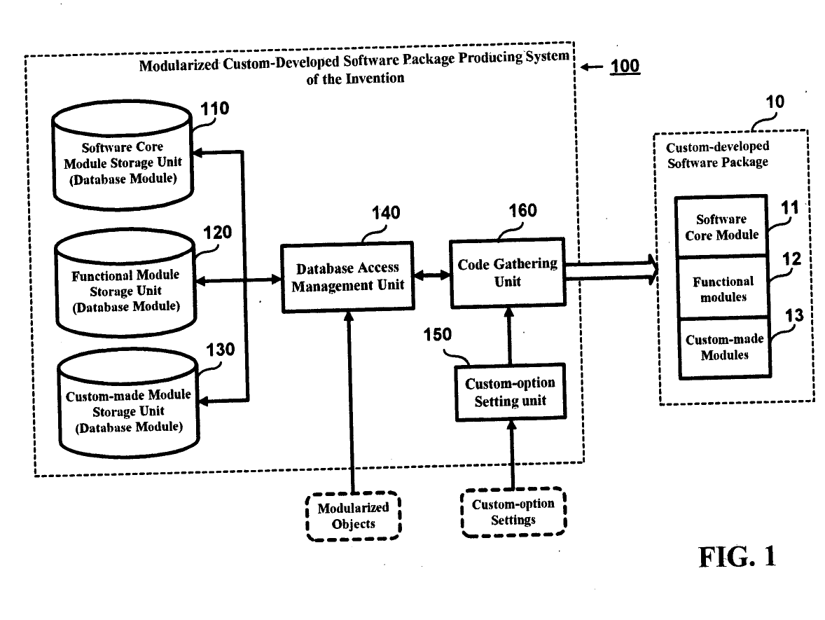

FIG. 1 is a schematic diagram showing an object-oriented component model of the modularized custom-developed software package producing system of the invention (as the part enclosed in the dotted box indicated by the reference numeral 100). As shown, the modularized custom-developed software package producing system of the invention 100 is designed to be capable of automatically producing a custom-developed software package 10 based on customer-designated specifications. Fundamentally, the custom-developed software package 10 should include a software core module 11, a set of functional modules 12, and a set of custom-made modules 13; wherein the software core module 11 is the core part of the custom-developed software package 10 that will be the same for all varieties of custom-developed software packages produced by the modularized custom-developed software package producing system of the invention 100; and the functional modules 12 and custom-made modules 13 are used to operate in cooperation with the software core module 11 to provide the intended functionality of the custom-developed software package 10, and which may be different in different varieties of custom-developed software packages produced by the modularized custom-developed software package producing system of the invention 100.

The object-oriented component model of the modularized custom-developed software package producing system of the invention 100 comprises: (a) a software core module storage unit 110; (b) a functional module storage unit 120; (c) a custom-made module storage unit 130; (d) a database access management unit 140; (e) a custom-option setting unit 150; and (f) a code gathering unit 160.

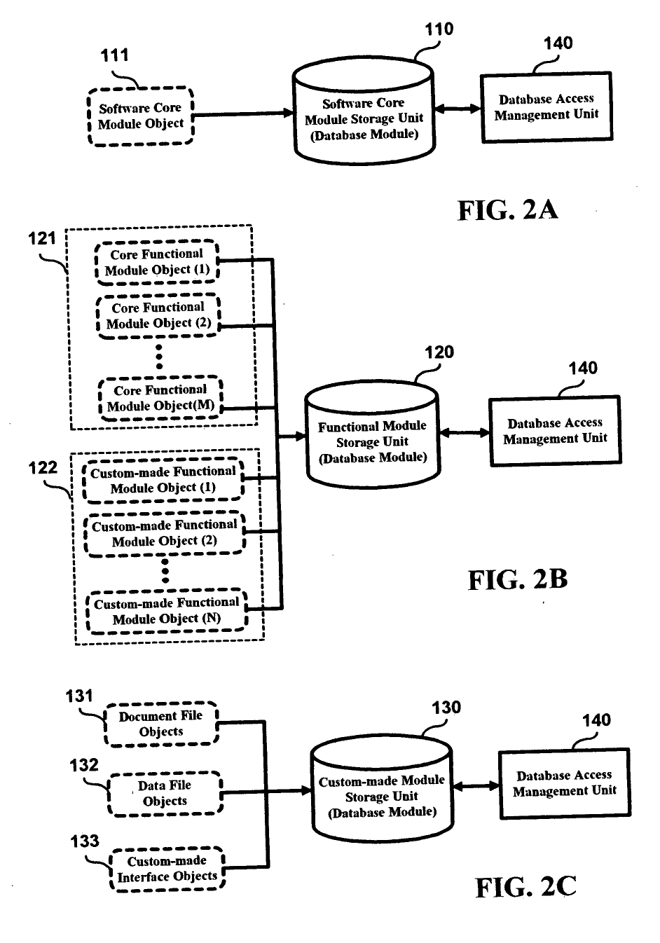

As shown in FIG. 2A, the software core module storage unit 110 is a database module which is used to store a pre-built software core module object 111 that is intended to be integrated to the custom-developed software package 10 and used as the software core module 11 in the custom-developed software package 10.

As shown in FIG. 2B, the functional module storage unit 120 is also a database module which is used to store a group of pre-built functional module objects including a group of core functional module objects 121 and a group of custom-made functional module objects 122 that are intended to be selectively integrated to the custom-developed software package 10 to serve as the functional modules 12 in the custom-developed software package 10. After these core functional module objects 121 and custom-made functional module objects 122 have been developed, they can be put into storage in the functional module storage unit 120 through the database access management unit 140.

As shown in FIG. 2C, the custom-made module storage unit 130 is also a database module which is used to store a group of custom-made module objects, including a group of document file objects 131, a group of data file objects 132, and a group of custom-made interface objects 133. These document file objects 131, data file objects 132, and custom-made interface objects 133 are stored through the database access management unit 140 into the custom-made module storage unit 130 only by authorized personnel, so that it can help prevent these document file objects 131 and data file objects 132 from unauthorized access or tampering.

The database access management unit 140 is a functional module that is used to control all access operations on the software core module storage unit 110, the functional module storage unit 120, and the custom-made module storage unit 130. The database access management unit 140 can be activated either by software development personnel or by the code gathering unit 160 for storage and retrieval of modularized objects (i.e., software core module object 111, core functional module objects 121, custom-made functional module objects 122, document file objects 131, data file objects 132, and custom-made interface objects 133) to and from the software core module storage unit 110, the functional module storage unit 120, and the custom-made module storage unit 130.

The custom-option setting unit 150 is a user-input interface module that allows software development personnel to choose a set of custom-options that specify a set of required module objects from the core functional module objects 121, the custom-made functional module objects 122, the document file objects 131, the data file objects 132, and the custom-made interface objects 133 that are intended to be integrated to the custom-developed software package 10. The specified settings are transferred to the code gathering unit 160.

The code gathering unit 160 is capable of gathering the required set of modularized objects from the core functional module objects 121, the custom-made functional module objects 122, the document file objects 131, the data file objects 132, and the custom-made interface objects 133 stored in the functional module storage unit 120 and the custom-made module storage unit 130 based on the specified-settings from the custom-option setting unit 150, as well as directly gathering the software core module object 111 from the software core module storage unit 110, so as to combine all these gathered objects into an integrated code package serving as the intended custom-developed software package 10.

In conclusion, the invention provides a modularized custom-developed software package producing method and system, which is capable of automatically producing a custom-developed software package based on customer-designated specifications; and which is characterized by the provision of all required functional and data objects as modularized objects, including a software core module object, a group of functional module objects including core functional module objects and custom-made functional module objects, and a group of custom-made module objects including document file objects, data file objects, and custom-made interface objects, which can be selectively chosen to be gathered and combined into an integrated code package serving as the intended custom-developed software package. Compared to prior art, the modularized custom-developed software package producing method and system according to the invention allows the overall software development process to be less laborious and time-consuming and thus more efficient to implement. Moreover, the invention can help prevent confidential business documents and data files that are embedded in the custom-developed software package from unauthorized access and tampering, since these files are stored by authorized personnel into the custom-made module storage unit and directly gathered and integrated to the custom-developed software package without human intervention. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A method for producing a custom-developed software package based on customer-designated specifications, comprising:
building a software core module storage unit, which is used to store a pre-built software core module object;
building a functional module storage unit, which is used to store a set of pre-built functional module objects;
building a custom-made module storage unit, which is used to store a set of custom-made module objects;
specifying a set of user-specified custom options that specify a set of functional module objects and custom-made module objects that are required for integration to the custom-developed software package; and
gathering the user-selected set of functional module objects and custom-made module objects respectively from the functional module storage unit and the custom-made module storage unit based on the user-specified custom options, as well as directly gathering the software core module object from the software core module storage unit, so as to combine the gathered software core module object, functional module objects, and custom-made module objects into an integrated code package serving as the intended custom-developed software package.

2. The method of claim 1, wherein the functional module objects stored in the functional module storage unit include a group of pre-built core functional module objects and a group of custom-made functional module objects.

3. The method of claim 1, wherein the custom-made module objects stored in the custom-made module storage unit include a group of document file objects, a group of data file objects, and a group of custom-made interface objects.

4. A modularized custom-developed software package producing system which is capable of automatically producing a custom-developed software package based on customer-designated specifications;
the modularized custom-developed software package producing system comprising:
a software core module storage unit, which is used to store a pre-built software core module object;
a functional module storage unit, which is used to store a set of pre-built functional module objects;
a custom-made module storage unit, which is used to store a set of custom-made module objects;
a database access management unit, which is used to control access operations on the software core module storage unit, the functional module storage unit, and the custom-made module storage unit;
a custom-option setting unit, which is a user-input module for inputting a set of user-specified custom options that specify a set of functional module objects and custom-made module objects that are required for integration to the custom-developed software package; and
a code gathering unit, which is capable of gathering the user-selected set of functional module objects and custom-made module objects respectively from the functional module storage unit and the custom-made module storage unit based on the settings by the custom-option setting unit, as well as directly gathering the software core module object from the software core module storage unit, so as to combine the gathered software core module object, functional module objects, and custom-made module objects into an integrated code package serving as the intended custom-developed software package.

5. The modularized custom-developed software package producing system of claim 4, wherein the functional module objects stored in the functional module storage unit include a group of pre-built core functional module objects and a group of custom-made functional module objects.

6. The modularized custom-developed software package producing system of claim 4, wherein the custom-made module objects stored in the custom-made module storage unit include a group of document file objects, a group of data file objects, and a group of custom-made interface objects.
